(19) United States
(12) Patent Application Publication
(10) Pub. No.: US 2014/0064924 A1
(43) Pub. Date: Mar. 6, 2014

(54) TIP CLEARANCE PROBE FOR TURBINE APPLICATIONS

(71) Applicant: Eli Cole Warren, Wethersfield, CT (US)

(72) Inventor: Eli Cole Warren, Wethersfield, CT (US)

(21) Appl. No.: 13/598,705

(22) Filed: Aug. 30, 2012

(51) Int. Cl. G01M 15/14; F01D 25/00

(52) U.S. Cl. 415/118; 73/112.01

(57) ABSTRACT

A clearance probe includes a sensor component with a sensor face. A housing is arranged about the sensor component and includes multiple gas passage exit holes that are arranged about the sensor face and are operable to create a gas curtain circumferentially surrounding the sensor face. This gas curtain displaces a portion of the particles in the area between the probe and the blade tip, thereby improving the accuracy of the clearance measurement.

### BACKGROUND

The present disclosure relates generally to rotor tip clearance probes, and more specifically to an improved housing arrangement for the same.

Rotating machines, such as gas turbine engines, require optimized rotor tip clearances to be maintained within the rotating machine for proper operation of the rotating machine. In order to ensure that the proper blade tip clearance is achieved, it is common to include a tip clearance probe in the rotating machine to measure the clearance between the rotor blade tip and an interior surface of the outer air seals of the rotating machine.

Various types of tip clearance probes are utilized in the art to determine the tip clearances. However, due to the unknown composition of a gas flowing through the clearance region (the gap between the probe and rotor tip), the tip clearance probes can be inaccurate. In particular, the number and amount of particles such as dust, water vapor, or products of combustion between the probe and the blade tip at any given time is variable and unknown.

### SUMMARY

A clearance probe according to an exemplary embodiment of this disclosure, among other possible things includes a sensor component having a sensor face, a housing arranged about the sensor component, a plurality of gas passages within the housing, a probe face including the sensor face, the sensor face is circumscribed by a housing face, and the housing face comprises a plurality of gas passage exit holes arranged about the sensor face and operable to create an air curtain circumferentially surrounding the sensor face.

In a further embodiment of the foregoing clearance probe, a ceramic fitting is between the housing and the sensor component.

In a further embodiment of the foregoing clearance probe, a gas cooling system is operable to cool the housing of the clearance probe.

In a further embodiment of the foregoing clearance probe, the gas cooling system comprises a cooling gas inlet connected to the plurality of gas passages such that each of the gas passages is operable to cool the clearance probe.

In a further embodiment of the foregoing clearance probe, the gas cooling system includes a cooling gas at least partially comprising GN2.

In a further embodiment of the foregoing clearance probe, the housing further comprises a gas inlet connected to the plurality of gas passages via a manifold.

In a further embodiment of the foregoing clearance probe, an upper ceramic is contacting the sensor component and a housing cap.

In a further embodiment of the foregoing clearance probe, the sensor component is a capacitive sensor component.

In a further embodiment of the foregoing clearance probe, the sensor component is a sensor type selected from a microwave sensor component, an eddy current sensor component, or a laser blade tip clearance sensor.

In a further embodiment of the foregoing clearance probe, each of the gas passage exit holes is arranged approximately equal distance from each adjacent gas exit hole, thereby creating an evenly distributed gas curtain.

A clearance probe according to an exemplary embodiment of this disclosure, among other possible things includes a method for detecting a rotor clearance circumscribing a sensor face of a tip clearance probe with a gas curtain such that particulate passing through a sensed region is minimized.

In a further embodiment of the foregoing method, an additional step of passing a gas through the clearance probe housing, and ejecting the gas from a plurality of gas exit holes on a sensor face of the tip clearance probe, thereby creating the gas curtain is performed.

In a further embodiment of the foregoing method, the step of passing a gas through the tip clearance probe housing comprises passing a cooling gas through the housing, thereby cooling the tip clearance probe.

In a further embodiment of the foregoing method, passing the cooling gas through the tip clearance probe housing comprises passing nitrogen gas through the tip clearance probe housing.

A turbine engine according to an exemplary embodiment of this disclosure, among other possible things includes a gas path including a plurality of rotors and stators, a clearance probe configured to detect a clearance between at least one of the rotors and an outer diameter wall of the gas path, the clearance probe comprises, a sensor component having a sensor face, a housing arranged about the sensor component, a plurality of gas passages within the housing, a probe face including the sensor face, wherein the sensor face is circumscribed by a housing face, and wherein the housing face comprises a plurality of gas passage exit holes arranged about the sensor face and operable to create a gas curtain circumferentially surrounding the sensor face.

In a further embodiment of the foregoing turbine engine, the clearance probe further comprises a ceramic fitting between the housing and the sensor component

In a further embodiment of the foregoing turbine engine, the clearance probe, further comprises a gas cooling system operable to cool the housing of the clearance probe.

In a further embodiment of the foregoing turbine engine, the gas cooling system comprises a cooling gas inlet connected to the plurality of gas passages such that each of the gas passages is operable to cool the clearance probe.

In a further embodiment of the foregoing turbine engine, the housing further comprises a gas inlet connected to the plurality of gas passages via a manifold.

In a further embodiment of the foregoing turbine engine, the sensor component is a capacitive sensor component.

In a further embodiment of the foregoing turbine engine, each of the gas passage exit holes is arranged approximately equal distance from each adjacent gas exit hole, thereby creating an evenly distributed gas curtain.

### DESCRIPTION OF THE FIGURES

The various features and advantages of the disclosed examples will become apparent to those skilled in the art from the detailed description. The figures that accompany the detailed description can be briefly described as follows:

FIG. 1 schematically illustrates a turbine engine gas path including a tip clearance probe.

FIG. 2 schematically illustrates an isometric view of a tip clearance probe.

FIG. 3 schematically illustrates a cross-sectional view of the tip clearance probe of FIG. 2.

FIG. 4 schematically illustrates an operational side view of the tip clearance probe of FIG. 2.

### DETAILED DESCRIPTION

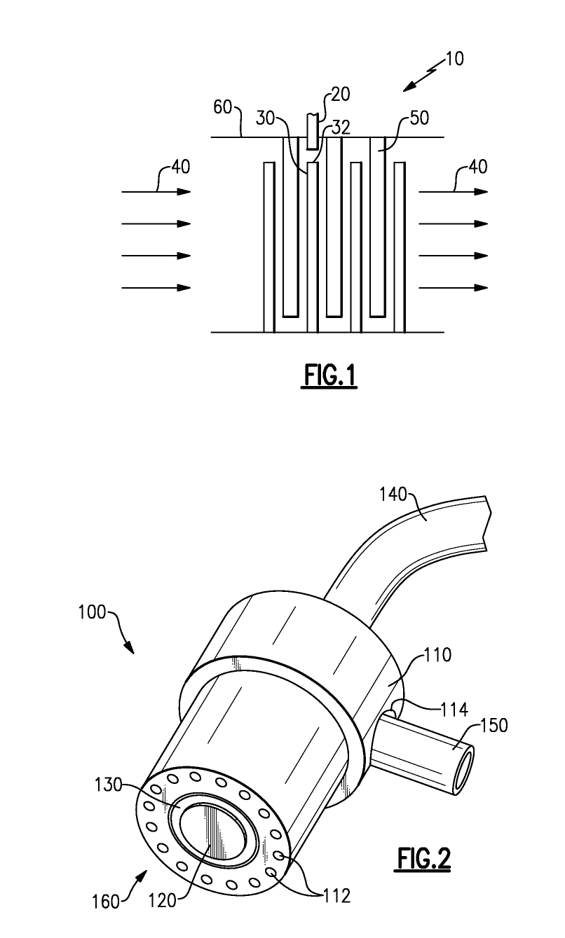

FIG. 1 schematically illustrates a portion of a gas path 10 that passes through a turbine engine. Included in the gas path 10 are multiple rotors 30 and stators 50. The rotors 30 are airfoil shaped blades that are forced to rotate due to expanding gases passing through the gas path 10. Each of the rotors 30 has a rotor tip 32. In order to validate the gas turbine engine design, the gap between the rotor blade tip 32 and the outer air seal must be accurately measured. In order to measure the tip clearance, a clearance probe 20 is included in the outer air seal 60 and measures the tip clearance (distance between the rotor tip 32 and the outer air seal 60) of a corresponding rotor 30. FIG. 1 is not drawn to scale, and certain elements, such as the clearance probe 20, are exaggerated for illustrative effect.

Due to the inherent nature of turbine engines, the gas 40 passing through the gas path 10 can vary in composition and can carry an indeterminate amount of particles such as dust, water vapor, or other products of combustion. The presence of particulate in the gas 40 in the flow-path 10 can undesirably affect the readings of a tip clearance probe.

FIG. 2 schematically illustrates a tip clearance probe 100 capable of providing accurate tip clearance measurements despite the presence of unknown particulates in the gas 40 passing through the gas path 10 (illustrated in FIG. 1). The tip clearance probe 100 includes a housing 110 containing a sensor component 120. A ceramic insulator 130 positions the sensor component 120 within the housing 110 and holds the sensor component 120 in place. An electrical lead 140 extends out of the housing 110 and connects the tip clearance probe 100 to a signal conditioner (not pictured).

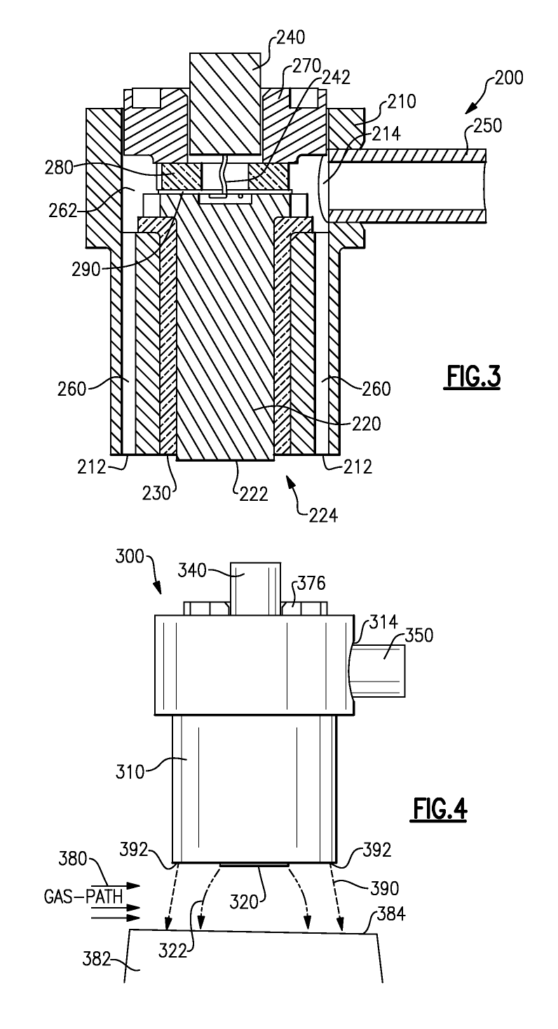

The tip clearance probe 100 also includes a sensor face 160 that is positioned facing a corresponding rotor tip when the tip clearance probe 100 is in an installed position. A gas/cooling inlet tube 150 is connected to the tip clearance probe 100 via a housing manifold inlet opening 114. The sensor face 160 also includes multiple gas exit holes 112 that expel gas inserted into the housing manifold (illustrated in FIG. 3) via the gas/cooling inlet tube 150. The gas is expelled toward the corresponding rotor tip 32.

In the illustrated example of FIG. 2, the gas/cooling inlet tube 150 facilitates an insertion of a cooling gas, such as nitrogen (GN2), into the housing manifold. As the cooling gas passes through the housing 110, the cooling gas cools the housing 110, ensuring that the tip clearance probe 100 stays within standard clearance probe temperature parameters and does not overheat. In alternate examples the cooling system for the tip clearance probe 100 can be a separate system and the gas/cooling inlet tube 150 can insert any gas capable of generating an air curtain effect (described below with regards to FIG. 4).

FIG. 3 illustrates a cross-sectional view of a tip clearance probe 200, such as the tip clearance probe 100 illustrated in FIG. 2. As with the example of FIG. 2, the tip clearance probe 200 includes a housing 210 containing a sensor component 220. The sensor component 220 is maintained in position within the housing via a lower ceramic insulator 230 and an upper ceramic insulator 280. An electric lead 240 extends out of the top of the tip clearance probe 200. The electric lead 240 is connected to the sensor component 220 via a sensor wire 242 and transmits sensor data to a signal conditioner (not pictured). The sensor wire 242 is maintained in contact with the sensor component 220 via a strap 290.

Each of the ceramic insulators 230, 280, the sensor component 220, the strap 290 and the electric lead 240 are held in place by a cap 270 that exerts a downward pressure on the internal components of the clearance probe 200. The cap 270 is maintained in place by any known technique such as welding or press fitting to the housing.

Inside the housing 210 is a housing manifold 262 that receives a gas from a gas/cooling inlet tube 250 via a housing manifold input opening 214. The gas is distributed from the housing manifold 262 to each of multiple gas exit holes 212 on the sensor face 224 via gas passages 260 that connect the housing manifold 262 to the gas exit holes 212. The gas exit holes 212 are located on a sensor face 224 of the tip clearance probe 200 and surround a sensor component face 222 thereby generating an air curtain effect surrounding the sensed region and displacing problematic gas-path elements.

The sensor components 120, 122 described above with regards to FIGS. 2 and 3 are capacitance based proximity sensors. However, alternate types of sensors such as laser blade tip clearance sensors and microwave tip clearance sensors can also be beneficially used in the described arrangement.

FIG. 4 illustrates a side view of a tip clearance probe 300 in operation. During operation of the turbine engine, the capacitance based tip clearance probe 300 sensor component detects the tip clearance based on the dielectric strength of the gap between the sensor face 320 and the rotor tip 382 using an electric field 322. As described above, the gas flow 380 passing through the gap can carry with it particles that affect the dielectric strength of the gap or otherwise skew the measurements of the sensor component 320. In order to prevent the particulate from passing through the gap, and thereby skewing the dielectric strength of the gap, gas exit holes 392 expel gas toward a rotor tip 384 passing below the tip clearance probe 300. The expelled gas creates an obstruction 390 in the gas path 380 that prevents the gas and particulate from passing through the sensed region (the gap). This obstruction 390 is alternately referred to as an “air curtain”. The air curtain blocks a significant portion of the particles in the gas flow from passing through the electric field 322.

The gas used to generate the obstruction 390 is initially injected into the clearance probe 300 housing manifold through a gas/cooling injection tube 350 and a housing manifold inlet opening 314. The gas fills the manifold and is forced through the gas passages (illustrated in FIG. 3) with enough force to create the air curtain effect blocking particulates. Thus, the air curtain minimizes the amount of particulate passing through the gap and increases the reliability and accuracy of the tip clearance probe 300.

In some example arrangements, the gas used to create the air curtain is also used to cool the probe housing 310. In such an arrangement, the cooling gas can originate from a pressurized cooling gas storage device. In other example arrangements, the tip clearance probe 300 has an independent cooling system or is not directly cooled, and the pressurized gas can come from alternate sources such as a turbine engine compressor bleed.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A clearance probe comprising:
a sensor component having a sensor face;
a housing arranged about the sensor component;
a plurality of gas passages within the housing;
a probe face including the sensor face, wherein the sensor face is circumscribed by a housing face; and
wherein said housing face comprises a plurality of gas passage exit holes arranged about the sensor face and operable to create an air curtain circumferentially surrounding the sensor face.

2. The clearance probe of claim 1, further comprising a ceramic fitting between the housing and the sensor component.

3. The clearance probe of claim 1, further comprising a gas cooling system operable to cool the housing of the clearance probe.

4. The clearance probe of claim 3, wherein said gas cooling system comprises a cooling gas inlet connected to said plurality of gas passages such that each of said gas passages is operable to cool the clearance probe.

5. The clearance probe of claim 3, wherein said gas cooling system includes a cooling gas at least partially comprising GN2.

6. The clearance probe of claim 1, wherein said housing further comprises a gas inlet connected to the plurality of gas passages via a manifold.

7. The clearance probe of claim 1, further comprising upper ceramic contacting said sensor component and a housing cap.

8. The clearance probe of claim 1, wherein said sensor component is a capacitive sensor component.

9. The clearance probe of claim 1, wherein said sensor component is a sensor type selected from a microwave sensor component, an eddy current sensor component, or a laser blade tip clearance sensor.

10. The clearance probe of claim 1, wherein each of said gas passage exit holes is arranged approximately equal distance from each adjacent gas exit hole, thereby creating an evenly distributed gas curtain.

11. A method for detecting a rotor clearance comprising the step of:
circumscribing a sensor face of a tip clearance probe with a gas curtain such that particulate passing through a sensed region is minimized.

12. The method of claim 11, further comprising the steps of:
passing a gas through clearance probe housing; and
ejecting said gas from a plurality of gas exit holes on a sensor face of said tip clearance probe, thereby creating said gas curtain.

13. The method of claim 12, wherein said step of passing a gas through the tip clearance probe housing comprises passing a cooling gas through said housing, thereby cooling said tip clearance probe.

14. The method of claim 13, wherein passing said cooling gas through said tip clearance probe housing comprises passing nitrogen gas through said tip clearance probe housing.

15. A turbine engine comprising:
a gas path including a plurality of rotors and stators;
a clearance probe configured to detect a clearance between at least one of said rotors and an outer diameter wall of said gas path, wherein said clearance probe comprises;
a sensor component having a sensor face;
a housing arranged about the sensor component;
a plurality of gas passages within the housing;
a probe face including the sensor face, wherein the sensor face is circumscribed by a housing face; and
wherein said housing face comprises a plurality of gas passage exit holes arranged about the sensor face and operable to create a gas curtain circumferentially surrounding the sensor face.

16. The turbine engine of claim 15, wherein said clearance probe further comprising a ceramic fitting between the housing and the sensor component.

17. The turbine engine of claim 15, wherein said clearance probe, further comprising a gas cooling system operable to cool the housing of the clearance probe.

18. The turbine engine of claim 17, wherein said gas cooling system comprises a cooling gas inlet connected to said plurality of gas passages such that each of said gas passages is operable to cool the clearance probe.

19. The turbine engine of claim 15, wherein said housing further comprises a gas inlet connected to the plurality of gas passages via a manifold.

20. The turbine engine of claim 15, wherein said sensor component is a capacitive sensor component.

21. The turbine engine of claim 15, wherein each of said gas passage exit holes is arranged approximately equal distance from each adjacent gas exit hole, thereby creating an evenly distributed gas curtain.
